(19) United States
(12) Patent Application Publication
(10) Pub. No.: US 2016/0031381 A1
(43) Pub. Date: Feb. 4, 2016

(54) Apparatus for Adjusting Application Angle of Portable Device

(71) Applicant: Ming Cheng Lin, New Taipei City (TW)

(72) Inventor: Ming Cheng Lin, New Taipei City (TW)

(21) Appl. No.: 14/450,283

(22) Filed: Aug. 4, 2014

(51) Int. Cl. B60R 11/00

(52) U.S. Cl. CPC B60R 11/00

(57) ABSTRACT

An apparatus for adjusting application angle of portable device includes an accommodating unit, a base, a joining unit, and a strapping unit. The accommodating unit and the base can have the turning angle adjusted right and left. The base and the joining unit can have the turning angle adjusted up and down. The joining unit and the strapping unit can jointly clamp on handle to collectively achieving the effect of adjusting application angle for portable device.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The Present invention relates to adjusting application angle of portable device, and particularly to an apparatus for adjusting application angle of portable device applying on equipment with handle.

2. Description of Related Arts

When an equipment with handle is used (such as bicycle, sporting goods, etc) and a portable device is desired to used at same time, the equipment shall be stopped firstly, so that the user is able to pick up the portable device from his pocket or elsewhere to use it.

When a portable device is used, holding the device with hand (s) could affect the convenience in using the equipment and the portable device at the same time.

Previous designs for using portable device on equipment with handle remain the above issues to be solved and/or improved.

### SUMMARY OF THE PRESENT INVENTION

An apparatus for adjusting application angle of portable device comprises an accommodating unit, a base, a joining unit, and a strapping unit. The accommodating unit and the base can have the turning angle adjusted right and left. The base and the joining unit can have the turning angle adjusted up and down. The joining unit and the strapping unit can jointly clamp on handle to collectively achieving the effect of adjusting application angle for portable device.

Representing Figure: FIG. 1

In viewing of the issues existed with previous techniques, the present invention provides an apparatus for adjusting application angle of portable device, which employs rotating angle structure to attain the effect of adjusting application angles.

For the present invention, the accommodating unit contains one accommodating space and a joining portion. The accommodating space is for accommodating portable device and it is located at the top surface of the accommodating unit. The joining portion is at the bottom surface of the accommodating unit. The base includes one first base and one end of the first base that can combine into the joining device of the accommodating unit.

For an alternative mode, the structure further has a water-proof sleeve which can fit to the top surface of the accommodating unit.

For another alternative mode, the base is a reading rack and the reading rack further includes one Joining Portion and a supporting portion. The joining portion is located at one end of reading rack and can be joined with the joining portion of the joining portion of the accommodating unit. The supporting portion is located at the other end of the reading rack and one end of the supporting portion is connected to the joining portion of the reading rack with angle adjustable. In such a way, the reading rack and the portable device are combined to use on a device with a flat surface and with the effect of that application angle can be adjusted.

For another alternative mode, the base further includes one adjustable base and one second base. The adjustable base again includes one first joining portion and one second joining portion. The first joining portion is located at one end of the adjustable base and connects to the bottom surface of the other end of first base. The second joining portion is located at the other end of the adjustable base. The second base has one fixing portion and the fixing portion is located at one end of the second base and firmly connected to the other end of first base and clamped the adjustable base. Also the structure further includes one joining portion and one strapping unit to attain the effect of adjusting the application angle for the structure and a portable device while applying jointly onto the handle device.

The the joining unit further includes one first joining portion, one second joining portion, one third joining portion, one penetrated port and one holding-clamping portion and one clamping portion. The first joining portion is located at one end of the joining unit and joined to the second joining portion of the adjusting base. The penetrated port is located at both side of the joining portion and passed through the joining unit. The third joining portion is located on the joining unit. The clamping portion has a design of resetting automatically after being turned and is equipped with one fourth joining portion and the fourth joining portion is located at both sides of the holding-clamping portion. The fourth joining portion fits into the penetrating port and joins with the third joining portion of the joining unit. The second joining portion is located at one end of the penetrated port and the clamping portion is at the other end of the joining unit.

There, the strapping unit further includes one first joining portion, one second joining portion, and one clamping portion. The first joining portion is located at one end of the strapping unit and fitted into the second joining portion of the joining unit and is prevented at one end of the holding-clamping portion. The second joining portion is located at the other end of the strapping unit and can insert into the penetrated port of the joining unit and clamp at the other end of the holding-clamping portion. The clamping portion is located on one side of the strapping unit and together with the clamping portion of the joining unit, they camped on one handle.

There, the first base further includes one fixing unit, one releasing portion, one joining portion, one cover plate and one first fixing portion. The fixing unit includes one second fixing portion and one second fixing portion. The second fixing portion is located at one end of the fixing unit and the third fixing portion is located at the other end of the fixing unit and firmly connected to the fixing portion of the second base. The second fixing portion fixed into the releasing portion on one surface and one side of the joining portion is fitted into the other side of the releasing portion and the joining portion of the first base can connected to the connecting portion of the accommodating unit, and the releasing portion can release the joining between the joining portion of first base and the joining portion of the accommodating unit. The cover plate cap in to the other side of the joining portion The first fixing portion is connected to the second joining portion of the fixing unit and clamps the cover plate, the joining portion of first base, and the releasing portion.

### BRIEF DESCRIPTION OF THE DRAWINGS

FIG. 1 is a perspective dissembled drawing of an implementation of the present invention.

FIG. 2 is a perspective dissembled drawing of first base of the implementation of the present invention.

FIG. 3 is a perspective view of an implementation of the present invention.

FIG. 4 is a perspective view of an application of an implementation of the present invention.

FIG. 5 is another perspective view of an implementation of the present invention.

### DETAILED DESCRIPTION OF THE PREFERRED EMBODIMENT

In coping with the diagrammatic presentation, the better implementations of the present invention are detailed in the following:

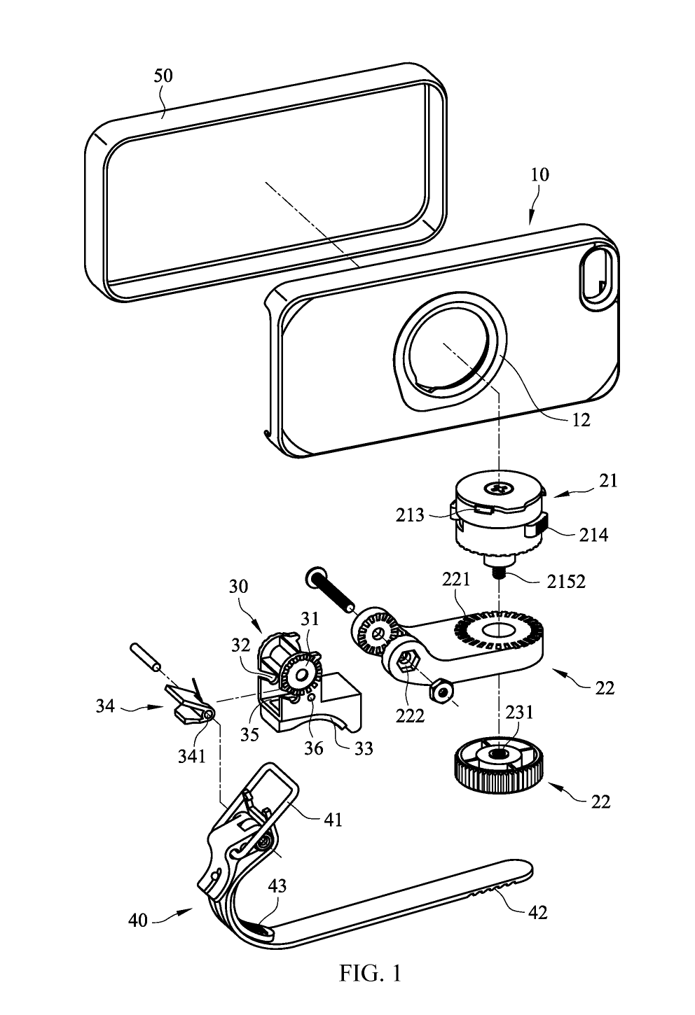

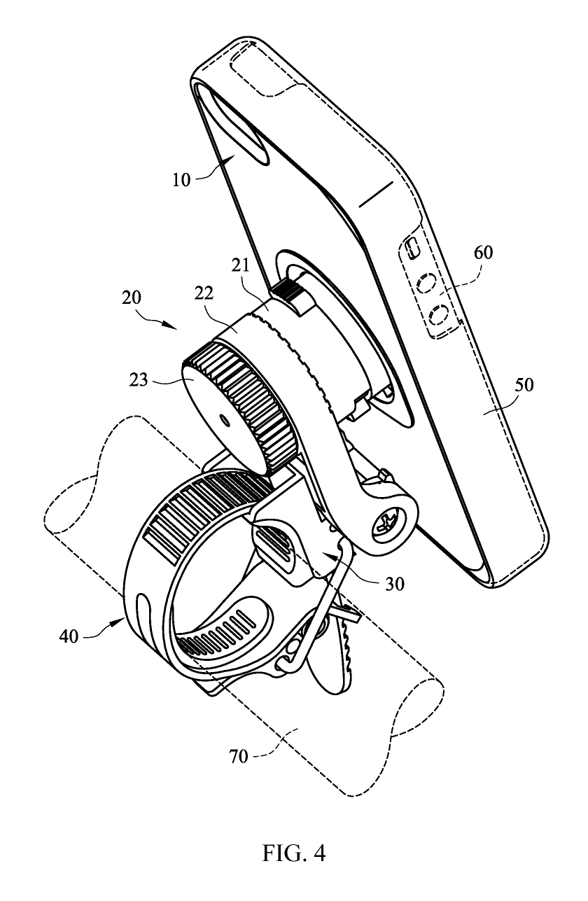

Please referring to FIG. 1 through FIG. 5, the present invention provides an apparatus for adjusting application angle of portable device which includes one accommodating unit (10) and one base (20)

The accommodating unit (10) further comprises one accommodating space (11) and one joining portion (12). The Accommodating space (11) is a space for accommodating portable device (60) and is located at top surface of the accommodating unit (10). The joining portion (12) is located at the bottom of the accommodating unit (10). The base (20) includes one first base (21) and one end of the said first base (21) can join with the joining portion (12) of the accommodating unit (10).

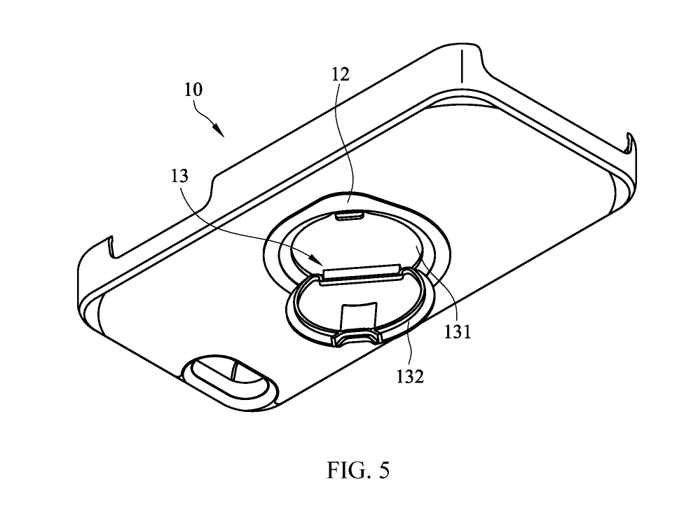

As shown in FIG. 5, the first base (21) is a reading rack (80) and the reading rack (80) further comprises one joining portion and (81) one brace (82). The joining portion (81) is located at one end of the reading rack (80) and can join with the joining portion (12) of the accommodating unit (10). The brace (82) is located at the other hand of the reading rack (80) and one end of the brace (82) is connected to the joining portion (81) and the angle is adjustable.

At first, place the Portable device (60) into the accommodating space (11) of the accommodating unit (10). Thereafter, the joining portion (81) of reading rack (80) joins with the joining portion (12) of the accommodating unit (10). By adjusting the angle between the joining portion (81) of the reading rack (80) and the brace (82) of the reading rack (80), an angle is created between the brace (82) of reading rack (80) and the accommodating space (11) of the accommodating unit (11), so that when the reading rack (80) and the portable device (60) are used jointly on a device with a flat space, it has the angle adjustable effect.

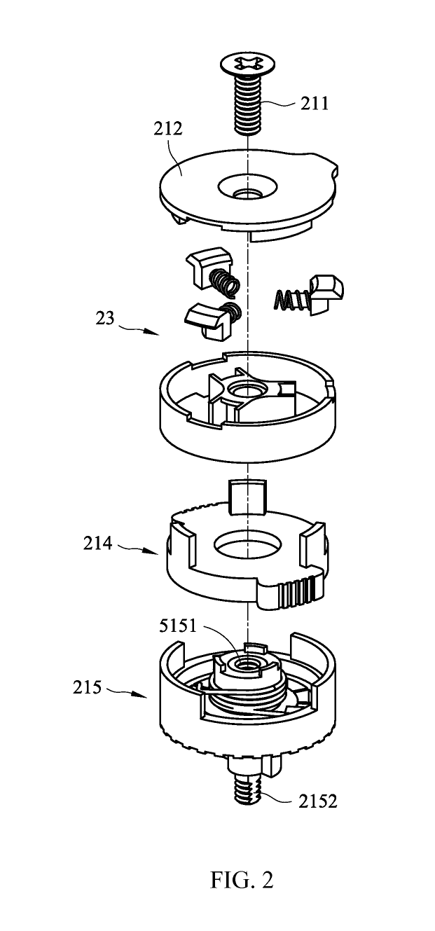

AS shown in FIG. 1 and FIG. 2, the apparatus for adjusting application angle of portable device according to the present invention further includes one joining unit (30), one strapping unit (40), and one water-proof sleeve (50).

The base 20 include one first base (21), one adjusting base (22), and one second base (23). The first base (21) further comprises one first fixing portion (211), one cover plate (212), one fixing portion (213), one releasing portion (214) and one fixing unit (215). The fixing unit (215) includes one second fixing portion (2151) and one third fixing portion (2152). The second fixing portion (2151) is located at one end of the fixing unit (215). The third fixing portion (2152) is located at the other end of the fixing unit (215). The adjustable base (22) further comprises one first joining portion (221) and one second joining portion (222). The first joining portion (221) is located at one end of the adjustable base 23 and the second joining portion 222 is located at the other end of base 23. The second base (23) is equipped with a fixing portion (231) and the fixing portion (231) is located at one end of second base (23)

The joining unit (30) further includes one first joining portion (31), one second joining portion (32), one third joining portion (33), one holding-clamping portion (34), one penetrating port (35) and one clamping portion (36). The first joining portion (31) is located at one end of the joining unit (30). The penetrated port (35) is located at both sides of the joining unit (30). The holding-clamping portion (34) has the function of resetting after rotating and is equipped with one fourth joining portion 341. The fourth joining portion 341 is located at both sides of the holding-clamping portion 34. The second joining portion (32) is located on one end of the penetrated port (35) of joining unit. The clamping portion 36 is located at the other ends of joining unit (30).

The strapping unit (40) comprises one first joining portion (41) , one second joining portion (42) and one clamping portion (43). The first joining portion is located at one end of the strapping unit (40). The second joining portion (42) is located at the other end of the strapping unit (40). The clamping portion (43) is located above one surface of strapping unit (40).

At first, fit the first base (21) and the second fixed portion (2151) into one side of the releasing portion (214). The joining portion (213) of the first base (21) fits into the other side of the releasing portion (214). The cover plate (212) fits into the other side of the joining portion (213) and the first fixing portion (211) of the first base (21) is connected to the second fixing portion (2151) of the first base (21) firmly. Then, close to fit the cover plate (212) and the joining portion (213) and the releasing portion (214) of the first base (21) to form the first base (21).

Thereafter it connects the first joining portion (221) of the adjustable base (22) to the bottom side of the fixing unit (215) of the first base and the fixing portion (231) of the base (23) connects firmly to the third fixing portion (2152) of the first base (21) and closes the adjustable base (23).

Then, the first joining portion (31) of joining unit (30) joins with the second joining portion (222) of base (23) and the fourth joining portion (341) of the holding-clamping portion (34) fits into the penetrated port (35) and joins with the third joining portion (33) of the joining unit (30).

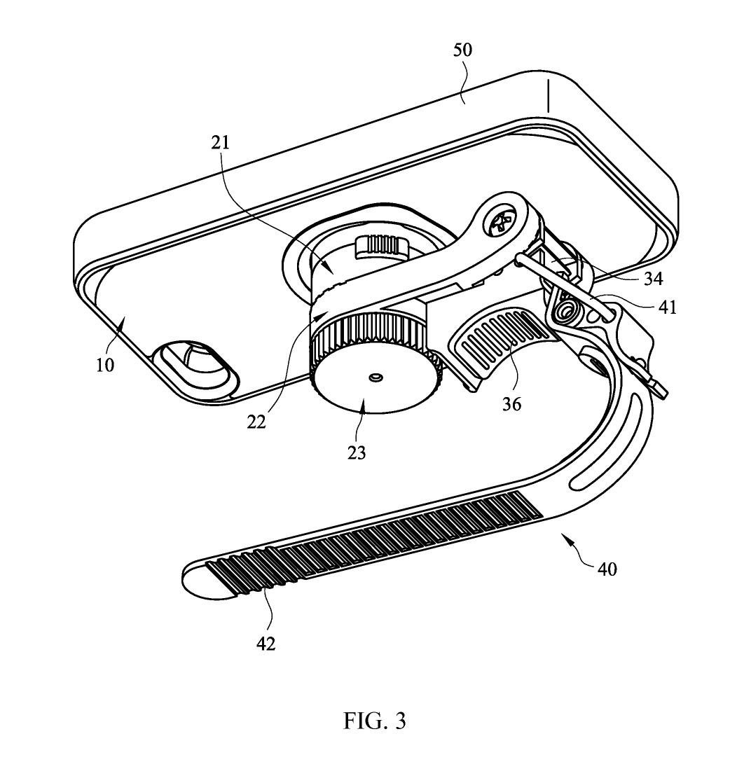

And, the joining portion (41) of the strapping unit (40) fits into the joining portion 32 of the joining unit (30) and stops at one end of the holding-clamping portion (34), as shown in FIG. 3. The second joining portion (42) of the strapping unit (40) inserts into the penetrated port (35) of the joining unit (30) and clamps at the other end of holding-clamping portion 34 of the joining unit (30)

Thereafter, the ring formed with the strapping unit (40) and the joining unit (30) fits into the handle (70). Fastening the second joining portion (42) of the strapping unit (40) causes the clamping portion (36) of joining unit and the clamping portion (43) of the strapping unit (40) to clamp on handle (70) tightly.

At last, the portable device (60) is placed into the accommodating space (11) of the accommodating unit (10) and the water-proof sleeve covered the top surface of accommodating unit (10) and the joining portion (213) of first base (21) joins joining portion (12) of the accommodating unit (10), which allows the up and down angle of the first joining portion (31) of the joining unit (30) and the second joining portion 222 of adjustable base (23) and further adjust the right and left angle of first joining portion (221) of the adjustable base (22) and the first base (21) so to achieve the purpose of the adjusting the portable device (60) on the handle (70) to a proper angle.

If the accommodating unit (10) is to be separated from the base (20) and turn the releasing portion (214) of the first base, it will separate the joining portion 213 of first base (21) and the joining portion (12) of the accommodating unit (10).

What is claimed is:

1. An apparatus for adjusting the application angle of portable device including:
an accommodating unit which has:
an accommodating space, which is a space capable to accommodate portable device and is located at the top side of the accommodating unit; and
a joining portion, which is located at bottom side of the accommodating unit; and
a base including one first base, wherein one end of the first base can join with the joining portion of the accommodating unit.

2. The apparatus, as recited in claim 1, wherein the base further includes:
an adjusting base which has:
a first joining portion located at one end of the adjusting base and connected to the bottom side of the other end of the first Base; and
a second joining portion, which is located at the other end of the adjusting base ; and
a second base, which is equipped with a fixing portion that is located at one end of the second base and firmly connected to the other end of the first base and clamped the adjusting base ;
wherein the apparatus further has a joining portion which further includes:
a first joining portion at one end of the joining portion and joining with the second joining portion of the adjusting base
a penetrated port at both sides of the joining unit and passing through joining unit ;
a third joining portion on the joining unit;
a holding-clamping portion with the function of resetting after being rotated, which is equipped with one fourth joining portion at both sides of the holding-clamping portion fitting to the penetrated port and joining with the third joining portion of the joining unit;
a second joining portion at one end of the penetrated port of the joining unit; and
a clamping portion at the other end of the joining unit;
a strapping unit, which has:
a first joining portion at one end of the strapping unit fitted into the second joining portion of the joining unit and stopped at one end of the holding-clamping portion;
a second joining portion at the other end of the strapping unit inserted to the penetrated port of joining unit and covering the other end of the holding-clamping portion; and
a clamping portion at one side of the strapping unit covers one handle with the holding-clamping portion of the joining unit.

3. The apparatus, as recited in claim 2, wherein the first base further includes:
a fixing unit having:
a second fixing portion at one end of the fixing unit
a third fixing portion at the other end of the fixing unit firmly connected to the fixing Portion of the second base; and
a releasing portion fitting into one side of the releasing portion one joining portion having one side fit to the other side of the releasing portion to join to the joining portion of the accommodating unit; and
a cover plate capping to the other side of the joining portion; and
a first fixing portion firmly connected to the second fixing portion of the fixing unit and covering the cover plate and joining the joining portion and the releasing portion of the first base together.

4. The apparatus, as recited in claim 2, further including one water-proof sleeve fitting into the top side of the accommodating unit.

5. The apparatus, as recited in claim 3, further including one water-proof sleeve fitting into the top side of the accommodating unit.

6. The apparatus, as recited in claim 1, wherein the first base is a reading rack including:
a joining portion at one end of the reading rack fitted into the joining portion of the accommodating nit; and
a brace at the other end of the reading rack and one end of the brace connect to the joining portion.
